(19) United States
(12) Patent Application Publication
(10) Pub. No.: US 2023/0384629 A1
(43) Pub. Date: Nov. 30, 2023

(54) DISPLAY DEVICE

(71) Applicant: Funai Electric Co., Ltd., Osaka (JP)

(72) Inventor: Naoki NITANAI, Osaka (JP)

(21) Appl. No.: 18/321,288

(22) Filed: May 22, 2023

(30) Foreign Application Priority Data
May 31, 2022 (JP) 2022-88580

(51) Int. Cl. G02F 1/1333

(52) U.S. Cl. CPC G02F 1/133314; G02F 1/133322

(57) ABSTRACT

A display device comprises a display, a back member disposed rearward relative to the display, a plurality of light sources disposed between the display and the back member, an optical sheet disposed between the display and the light sources, at least one sheet support supporting the optical sheet from a back side of the optical sheet, and at least one base including a plurality of holders that are configured to hold the at least one sheet support, the at least one base being attached to the back member from a display unit side.

### CROSS-REFERENCE TO RELATED APPLICATIONS

This application claims priority to Japanese Patent Application No. 2022-88580 filed in Japan on May 31, 2022. The entire disclosure of Japanese Patent Application No. 2022-88580 is hereby incorporated herein by reference.

### BACKGROUND

### Field of the Invention

The present invention generally relates to a display device. More specifically, the present invention relates to a display device comprising a support member that supports an optical sheet from a back side.

### Background Information

There are conventional display devices equipped with a support member that supports an optical sheet from the back side (see Japanese Laid-Open Patent Application Publication No. 2013-161793 (Patent Literature 1), for example).

The above-mentioned Patent Literature 1 discloses a video display device equipped with a support member that supports an optical sheet from the back side. This video display device is provided with a lower chassis and a support member including supports and base portions. The supports are formed from a transparent material and have a flat shape. The base portions are made from the same transparent material as the supports, and are integrally formed with the supports. Also, the base portions include a fixing protrusion, and are configured to be fixed by inserting the fixing protrusion into a fixing hole provided in the lower chassis. Because the sheet supports that support the optical sheet from the back side are formed from a transparent material, the shadow caused when light from the light source units irradiates the supporting member is less likely to be visible on the screen of the video display device.

### SUMMARY

However, although not disclosed in the above-mentioned Patent Literature 1, different back members are used in different types (models) of display device even if the display size of the television is the same. More specifically, different types of display device having the same display size will have different LED arrangements and positions. Therefore, the proper positions of the sheet supports to keep the optical sheet flat will vary for each different type of display device with the same television display size. The “proper position” of a sheet support refers to a position where the shadow of the sheet support is least likely to appear because light interference is minimized. Therefore, the fixing holes for fixing the sheet supports must be provided at different positions for different display devices since the interference of light will be different with different display devices even though the display size of the television is the same. Accordingly, every time a different type of display device having the same television display size is manufactured, a mold for a different back member has to be produced in order to provide the sheet supports at the proper positions. Therefore, the above problem could be solved if a mold were produced in which the number of fixing holes for fixing the sheet supports was increased ahead of time. However, if the number of fixing holes is increased, then all of the fixing holes that are not used for fixing the sheet supports will have to be covered with screws. This is because light leaks from the fixing holes if they are not covered with screws. For this reason, it is preferable to keep the number of holes in the back member as small as possible.

One object of the present disclosure is to provide a display device with which, even if a common back member is used for display devices of different types having the same television display size, the increase in the number of holes made in the back member can be suppressed, while individual sheet supports can be disposed at the proper positions.

In view of the state of the known technology, a display device according to one aspect of the present disclosure comprises a display, a back member disposed rearward relative to the display, a plurality of light sources disposed between the display and the back member, an optical sheet disposed between the display and the light sources, at least one sheet support supporting the optical sheet from a back side of the optical sheet, and at least one base including a plurality of holders that are configured to hold the at least one sheet support, the at least one base being attached to the back member from a display unit side.

### BRIEF DESCRIPTION OF THE DRAWINGS

FIG. 1 is an oblique view of the overall configuration of a liquid crystal television device according to a first embodiment;

FIG. 2 is a rear view showing the overall configuration of the liquid crystal television device according to the first embodiment;

FIG. 3 is an exploded oblique view of the liquid crystal television device according to the first embodiment;

FIG. 4 is an oblique view of a base and sheet supports according to the first embodiment;

FIG. 5 is a view of the base and the sheet supports according to the first embodiment, as seen from a Y1 direction side;

FIG. 6 is a detail view of a holder according to the first embodiment;

FIG. 7 is a detail view showing a state in which a sheet support is engaged with the holder according to the first embodiment;

FIG. 8 is a partial cross-sectional view in the first embodiment;

FIG. 9 is a diagram of a rear frame on which light source substrates (TE type) are installed in the first embodiment, as seen from the Y1 direction side;

FIG. 10 is a diagram of a rear frame on which light source substrates (SE type) are installed in the first embodiment, as seen from the Y1 direction side;

FIG. 11 is a detail view of FIG. 9;

FIG. 12 is a detail view of FIG. 10;

FIG. 13 is a diagram of a base according to a second embodiment, as seen from the Y1 direction side; and

FIG. 14 is a diagram of a base in which a holding mechanism is provided with a holder through-hole for holding a sheet support, which is a modification example of the base, as seen from the Y1 direction side.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### First Embodiment

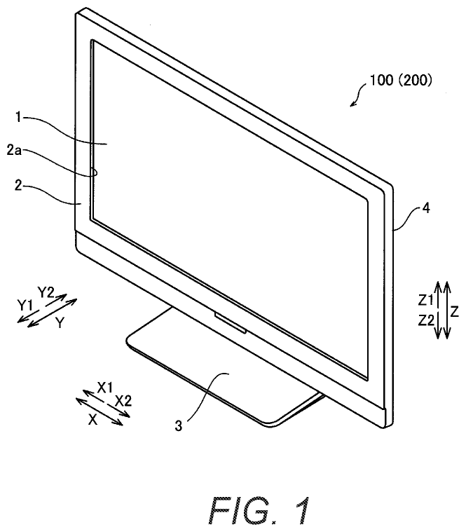

A configuration of a liquid crystal television device 100 according to a first embodiment will be described with reference to FIGS. 1 to 12. The liquid crystal television device 100 is an example of the “display device” of the present disclosure.

The liquid crystal television device 100 according to the first embodiment is provided with a display unit (e.g., a display) 1, as shown in FIG. 1. The display unit 1 is made up of liquid crystal cells, and is configured to be able to display video. In the following description, when viewed from a position opposite the display unit 1 of the liquid crystal television device 100, the left direction is referred to as an X1 direction, the right direction as an X2 direction, the front direction as a Y1 direction, the back direction as a Y2 direction, the upward direction as a Z1 direction, and the downward direction as a Z2 direction.

Also, the liquid crystal television device 100 is provided with a front housing or frame 2. The front housing 2 is made of resin. The front housing 2 is configured to support the display unit 1 from the Y1 direction side. A rectangular opening 2a is provided in the center of the front housing 2 to expose the display unit 1 in the Y1 direction.

The liquid crystal television device 100 is also provided with a stand member or stand 3. The stand member 3 is configured to support the entire liquid crystal television device 100 from the Z2 direction side. The liquid crystal television device 100 is also provided with a rear frame or housing 4 that is disposed rearward relative to the display unit 1. In particular, the rear frame 4 is disposed on the rear side (e.g., the back side), which is the opposite side from the display unit 1. The rear frame 4 is an example of the “back member” of the present disclosure.

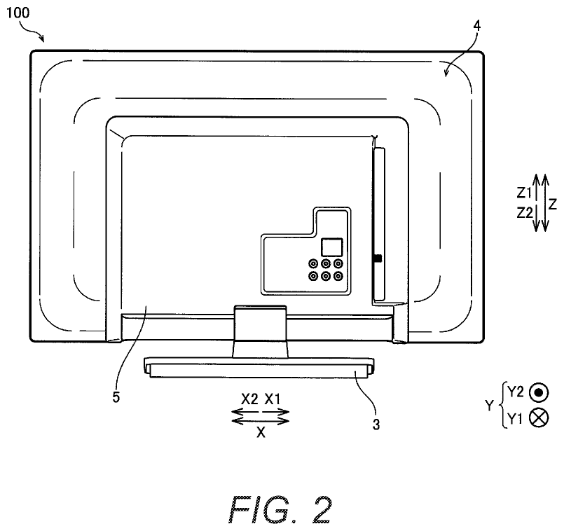

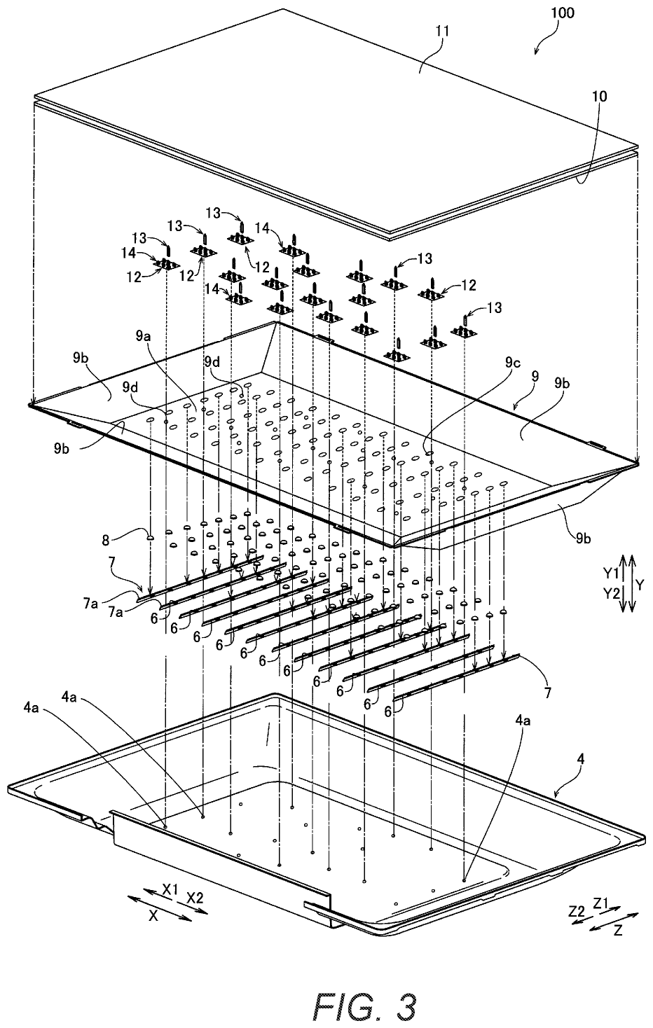

Also, as shown in FIG. 2, the rear frame 4 of the liquid crystal television device 100 is provided with an exposed rear portion. The rear frame 4 is formed from metal and has a concave shape that is recessed in the Y2 direction. The rear frame 4 is configured to be fitted together with the front housing 2 from the Y2 direction side. The rear frame 4 is fixed to the front housing 2 by threaded fasteners, such as screws (not shown). One rear frame 4 is provided for a plurality of bases 12 and includes one attachment portion 4a (in the form of a through-hole as seen in FIG. 3) for attaching each of the bases 12 to the rear frame 4. Thus, the rear frame 4 includes at least one attachment portion 4a for attaching the at least one base 12 to the rear frame 4, respectively. The at least one attachment portion 4a each includes a through-hole, as seen in FIG. 3. Specifically, in the illustrated embodiment, one rear frame 4 is provided for the plurality of the bases 12, and the rear frame 4 includes a plurality of through-holes for attaching the bases 12 to the rear frame 4, respectively. The number of the bases 12 attached to the rear frame 4 is equal to the number of the through-holes of the rear frame 4.

The liquid crystal television device 100 is also provided with a cover member 5. The cover member 5 is formed from resin and is smaller than the rear frame 4. The cover member 5 is disposed on the Y2 direction side of the rear frame 4. Also, the cover member 5 is provided so as to cover various substrates (not shown), such as a power supply substrate and a signal processing substrate, disposed on the rear surface of the rear frame 4 (the surface on the Y2 direction side). Also, the cover member 5 is fixed to the rear frame 4 by threaded fasteners, such as screws (not shown).

Also, as shown in FIG. 3, the liquid crystal television device 100 is provided with a plurality of LEDs (light emitting diodes) 6 disposed between the display unit 1 and the rear frame 4. The LEDs 6 are configured to emit light to the display unit 1 side (the Y1 direction side). The LEDs 6 are an example of the “light sources” of the present disclosure.

The liquid crystal television device 100 is also provided with light source substrates 7. In the illustrated embodiment, a plurality of (twelve in FIG. 3) light source substrates 7 are provided, which are disposed side by side on the Y1 direction side of the rear frame 4, and spaced apart in an X direction. In the illustrated embodiment, a plurality of (seven in FIG. 3) LEDs 6 are mounted on each of the light source substrates 7, and are spaced apart in the direction in which each of the light source substrates 7 extends (an Z direction). Also, the light source substrates 7 each further includes a plurality of (seven in FIG. 3) lenses 8, and a PCB (polychlorinated biphenyl) substrate 7a. The lenses 8 can be any of various types, depending on the required specifications, performance, and housing limitations.

The liquid crystal television device 100 is provided with the lenses 8. The lenses 8 are disposed one for each of the LEDs 6, so as to cover the LEDs 6 disposed on the light source substrates 7. The lenses 8 are made from acrylic or another such resin, and are configured so as to widen the emission angle of the light emitted from the LEDs 6. Also, the lenses 8 are fixed to the light source substrates 7 by being adhesively bonded to the surfaces of the light source substrates 7. The lenses 8 are an example of the “light sources” of the present disclosure. In the illustrated embodiment, pairs of the LEDs 6 and the lenses 8a can also be referred to as light source units.

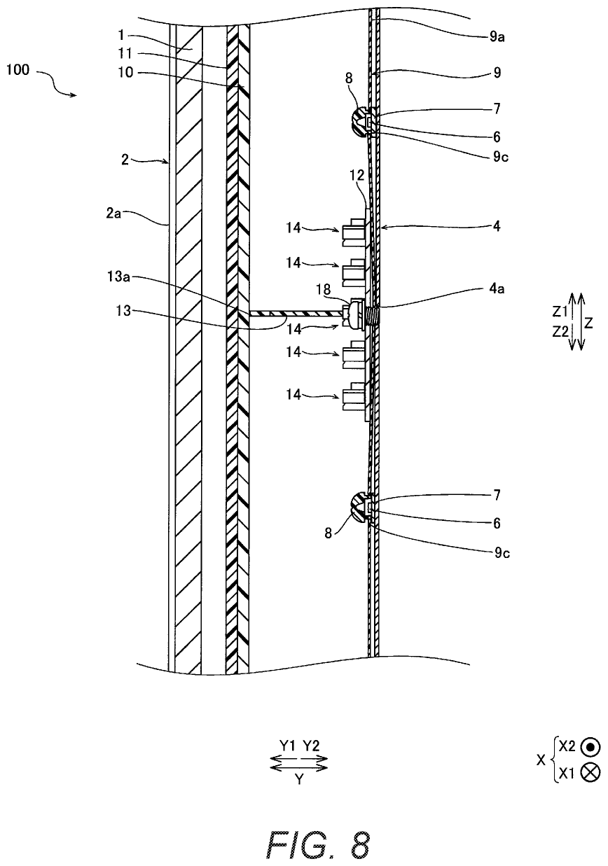

Also, as shown in FIG. 3, the liquid crystal television device 100 is provided with a reflective sheet 9 disposed between the display unit 1 and the LEDs 6. The reflective sheet 9 is provided between the rear frame 4 and a diffuser 10 (discussed below; see FIG. 8), and is configured to allow the light from the LEDs 6 to be reflected. More specifically, the reflective sheet 9 is made of a resin (such as PET (polyethylene terephthalate), etc.). The reflective sheet 9 is configured to have a shape conforming to the rear frame 4 (a concave shape that is recessed in the Y2 direction) in a state of being disposed on the surfaces of the light source substrates 7. More specifically, the reflective sheet 9 includes a reflective sheet bottom surface portion 9a having an oblong or rectangle shape extending in the X direction, and four reflective sheet sloped portions 9b disposed so as to surround the four sides of the reflective sheet bottom surface portion 9a. The diffuser 10 is an example of the “optical sheet” of the present disclosure.

Also, the reflective sheet bottom surface portion 9a is formed so as to extend parallel to the diffuser 10 and a polarizing film 11 (discussed below) (see FIG. 8). Also, the reflective sheet sloped portions 9b are each formed so as to extend at an angle from an end of the reflective sheet bottom surface portion 9a toward an edge of the rear frame 4 (see FIG. 3). The polarizing film 11 is an example of the “optical sheet” of the present disclosure.

As shown in FIG. 3, the reflective sheet bottom surface portion 9a of the reflective sheet 9 is provided with a plurality of light source openings 9c at positions corresponding to the positions where the plurality of (eighty-four in FIG. 3) LEDs 6 (7 LEDs×12 rows) are disposed. Furthermore, a plurality of base openings 9d are made in the reflective sheet bottom surface portion 9a. The base openings 9d are formed so that screws 18 (see FIG. 8) can pass through to attach the bases 12 to the rear frame 4. The screws 18 are an example of the “fastening member” of the present disclosure.

Also, as shown in FIG. 3, the liquid crystal television device 100 is provided with a diffuser 10. The diffuser 10 is formed from a resin or the like, and has a flat shape extending in the Z direction and the X direction. Also, the diffuser 10 is disposed between the display unit 1 and the LEDs 6, and is configured to diffuse the light from the LEDs 6 (see FIG. 8).

Also, as shown in FIG. 3, the liquid crystal television device 100 is provided with the polarizing film 11. The polarizing film 11 has a flat shape similar to that of the diffuser 10, and is formed to extend in the Z direction and the X direction. The polarizing film 11 is disposed between the diffuser 10 and the display unit 1, and is configured to align the polarization direction of the light transmitted through the diffuser so as to be emitted toward the display unit 1. Also, the display unit 1 is configured, for example, to change the transmissivity of the liquid crystals included in the display unit 1 with respect to the light emitted from the polarizing film 11 and whose polarization direction is aligned, so that an image is displayed.

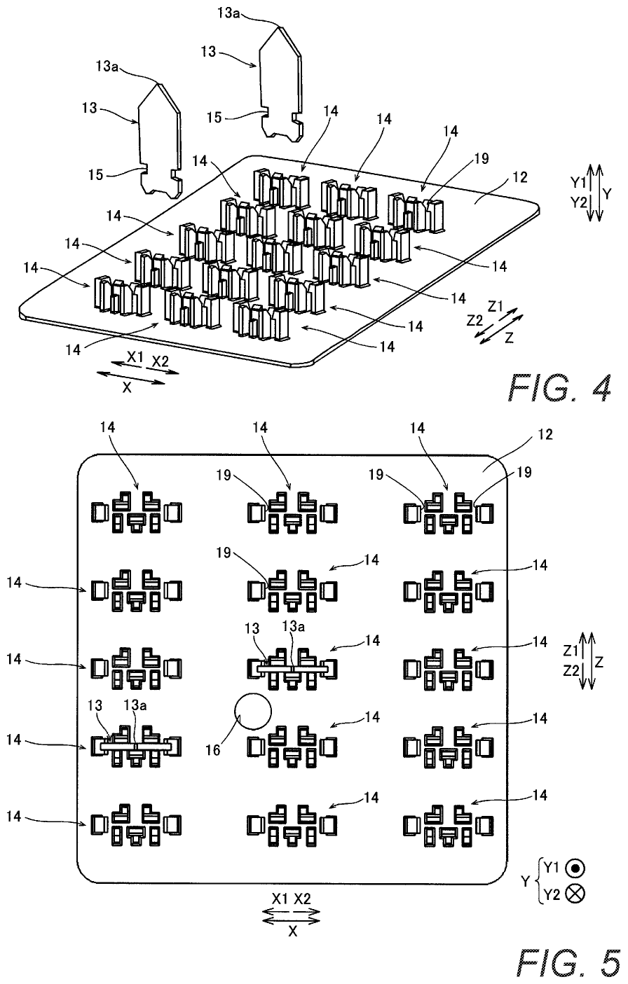

The liquid crystal television device 100 is provided with the bases 12. As shown in FIG. 4, each of the bases 12 includes at least one (two in FIG. 4) sheet support 13 that supports the diffuser 10 from the Y2 direction side (e.g., the back side) of the diffuser 10. Also, the bases 12 are attached to the rear frame 4 from the display unit 1 side. Each of the bases 12 includes a plurality of (fifteen in FIGS. 4 and 5) holders 14 that are configured to hold the at least one sheet support 13. As shown in FIG. 5, each of the bases 12 includes at least one (one in FIG. 5) through-hole 16 for attaching each of the bases 12 to the rear frame 4. In particular, as seen in FIG. 5, each of the bases 12 includes a base plate that includes the through-hole 16, and the holders 14 are integrally formed with the base plate as a one-piece, unitary member. The at least one sheet support 13 is independently formed as separate members from each of the bases 12. As shown in FIGS. and 8, each of the bases 12 is attached to respective one of the attachment portions 4a of the rear frame 4 by the screw 18 that is inserted into the through-hole 16. The rotational angle of each of the bases 12 is adjustable about the screw 18 along the rear frame 4, with the screw 18 at the center.

As shown in FIG. 8, the bases 12 are arranged such that the reflective sheet 9 is sandwiched between the bases 12 and the rear frame 4. More specifically, the screws 18 that are inserted into the through-holes 16 of the bases 12 are passed through the base openings 9d of the reflective sheet 9 and fastened to the attachment portions 4a. The bases 12 are fixed to the rear frame 4 while sandwiching the reflective sheet 9 therebetween.

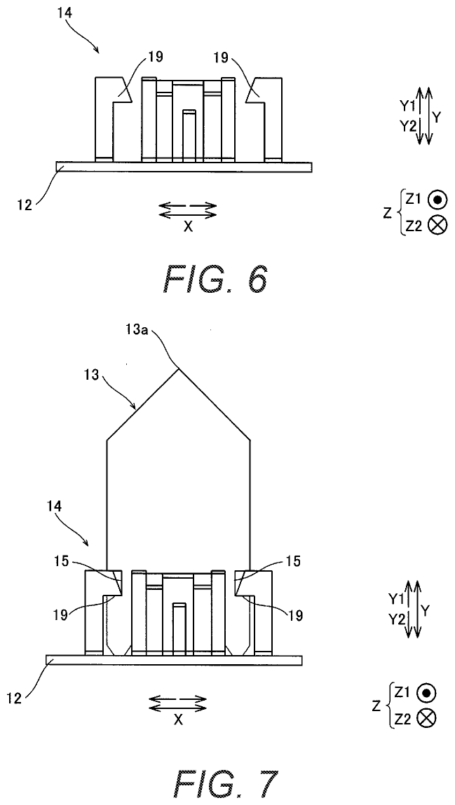

The at least one sheet support 13 is selectively attached to at least one of the holders 14 of each of the bases 12. The at least one sheet support 13 is made of a resin material through which the light from the LEDs 6 can pass. As shown in FIG. 4, the at least one sheet support 13 includes a flat plate with a pair of engaging portions 15 that engages with a pair of hook mechanisms (or hooks) 19 of the holder 14. The engaging portions 15 are provided to each of the at least one sheet support 13 on the rear frame 4 side (the Y2 direction), and are formed in a cutout shape so as to engage with the hook mechanisms 19 of the holder 14 (see FIG. 6). The at least one sheet support 13 is configured to be held upright in the vertical direction (the Y1 direction) with respect to the rear frame 4 by the holder 14 (see FIG. 7). The hook mechanisms 19 are an example of the “fixing mechanisms” of the present disclosure.

As shown in FIG. 4, the at least one sheet support 13 each includes a contact portion 13a. The contact portion 13a is provided at the distal end of each of the at least one sheet support 13 on the diffuser 10 side (the Y1 direction). The at least one sheet support 13 supports the diffuser 10 from the rear side (e.g., the back side) of the diffuser 10. More specifically, the at least one sheet support 13 is configured to support the diffuser 10 by bringing the contact portion 13a into point contact with the diffuser 10 from the Y2 direction side of the diffuser 10.

The holders 14 are made of a colored material (such as white) that suppresses the transmission of light from the LED 6 (low transmissivity). Each of the holders 14 has the hook mechanisms 19 that fix or are engaged with the at least one sheet support 13. Also, the at least one sheet support 13 can be detached from the holders 14 by means of the hook mechanisms 19 (see FIGS. 6 and 7). Thus, the holders 14 and the at least one sheet support 13 are detachably attachable by the hook mechanisms 19. In other words, the at least one sheet support 13 is each detachably and reattachably attachable to each of the bases 12. In particular, at least one sheet support 13 is each toollessly attachable to each of the bases 12. In the illustrated embodiment, as seen in FIGS. 4 and 5, two sheet supports 13 are attached to one base 12. However, of course, the number of sheet supports 13 attached to one base 12 is not limited to two, and can be one or more than two, as needed and/or desired. Furthermore, the number of sheet supports 13 attached to one base 12 can be different depending on the locations of the bases 12 relative to the rear frame 4. As seen in FIG. 5, the holders 14 also each includes a plurality of supports that sandwich a lower portion of each of the at least one sheet support 13 therebetween.

LED Arrangement Pattern

As seen in FIG. 3, the LEDs 6 are arranged in a plurality of (twelve in FIG. 3) rows (e.g., light source rows) on the rear frame 4. Each of the rows has a set of (seven) LEDs 6 that are linearly arranged relative to each other. The bases 12 are provided between adjacent pairs of the rows of the LEDs 6. Specifically, the rows of the LEDs 6 are formed by the light source substrates 7.

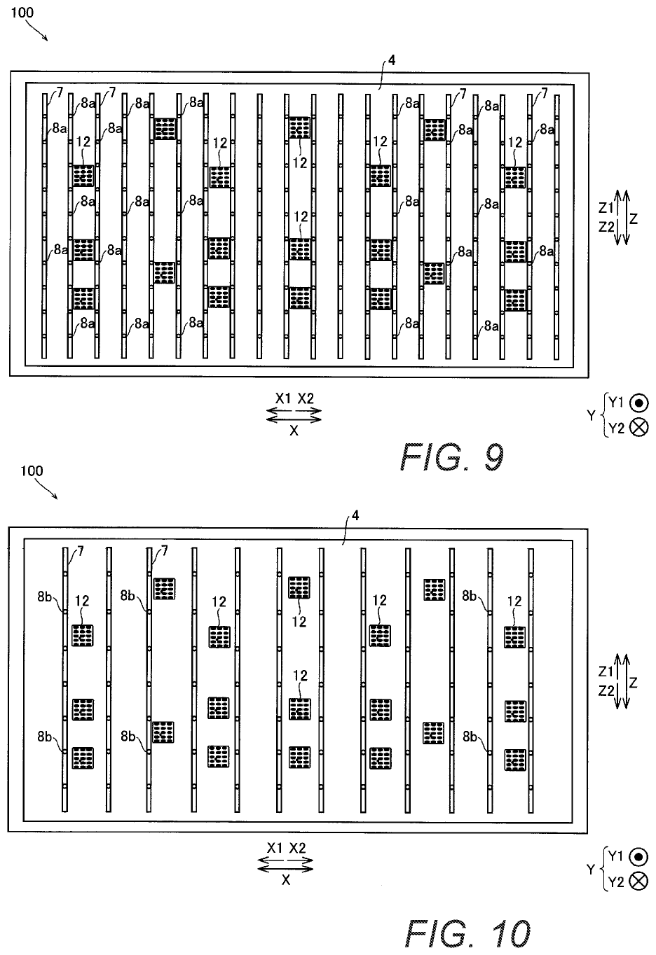

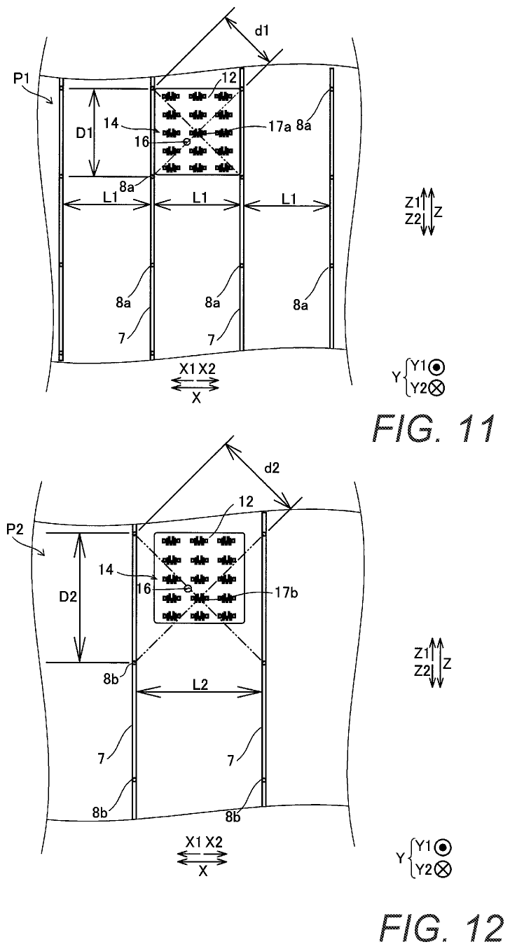

The LEDs 6 can be arranged relative to the rear frame 4 in different arrangement patterns. FIG. 9 illustrates a first arrangement pattern P1 of the LEDs 6. In the first arrangement pattern P1, twenty of the light source substrates 7 are provided on the rear frame 4. As seen in FIG. 11, the light source substrates 7 are substantially equidistantly spaced apart from each other at a distance of L1. When the LEDs 6 are arranged in the first arrangement pattern P1, a top-emission type (hereinafter referred to as TE type) of lens 8a is used for the light sources of the LEDs 6 in the light source substrates 7. In this case, ten of the LEDs 6 are provided to each of the twenty light source substrates 7. The TE-type lenses 8a are disposed so that the light from the LEDs 6 is emitted mainly upward (the Y1 direction).

FIG. 10 illustrates a second arrangement pattern P2 of the LEDs 6, as in FIG. 3. In the second arrangement pattern P2, twelve of the light source substrates 7 are provided on the rear frame 4. As seen in FIGS. 3 and 12, the light source substrates 7 are substantially equidistantly spaced apart from each other at a distance of L2. When the LEDs 6 are arranged in the second arrangement pattern P2, a side-emission type (hereinafter referred to as SE type) of lens 8b is used for the light sources of the LEDs 6 in the light source substrates 7. In this case, seven of the LEDs 6 are provided to each of the twelve light source substrates 7. The SE-type lenses 8b are disposed so that the light from the LEDs 6 is emitted mainly in the lateral direction.

As discussed above, there are two arrangement patterns of the LEDs 6. In the first arrangement pattern P1, the LEDs (e.g., the set of light sources) 6 are substantially equidistantly spaced apart at a first interval D1 along each of the row. In the second arrangement pattern P2, the LEDs (e.g., the set of light sources) 6 are substantially equidistantly spaced apart at a second interval D2 along each of the row, with the second interval D2 being larger than the first interval D1 (D2>D1), as seen in FIGS. 11 and 12). This is because the TE-type lenses 8a and the SE-type lenses 8b have different light diffusion directions. Therefore, the number of the LEDs 6 used and the spacing between the LEDs 6 are different (see FIGS. 9 and 10) depending on the type of the lenses 8a and 8b. Since the SE-type lenses 8b diffuse the light in the lateral direction, a larger distance (D2>D1) (see FIGS. 11 and 12) can be obtained than when the TE-type lenses 8a are used. Accordingly, the number of the LEDs 6 can be reduced by using the SE-type lenses 8b.

Also, as shown in FIGS. 9 and 10, since the spacing between the LEDs 6 is different between the first arrangement pattern P1 and the second arrangement pattern P2, the proper position at which the at least one sheet support 13 is disposed is also different. Accordingly, the locations of the at least one sheet support 13 need to be suitably decided for each arrangement pattern. Therefore, the holders 14 are provided so as to be compatible with both the first arrangement pattern P1 and the second arrangement pattern P2. Also, as shown in FIGS. 11 and 12, the holders 14 are provided so that the distance d2 between the LEDs 6 and the holder 14 holding the sheet support 13 in the second arrangement pattern P2 will be greater than the distance d1 between the LEDs 6 and the holder 14 holding the sheet support 13 in the first arrangement pattern P1 (d2>d1).

Also, as shown in FIGS. 11 and 12, the base 12 is attached to the rear frame 4 at a position where the sheet support 13 is on the intersection 17a or 17b of four LEDs 6. Installing at this position keeps the influence of the shadow of the sheet support 13 caused by the light emitted from the LEDs 6 to a minimum with respect to the display unit 1. Thus, in the illustrated embodiment, each of the bases 12 is attached to the rear frame 4 such that the sheet supports 13 is located at an intersection of diagonal lines of four of the LEDs 6. In other words, the sheet supports 13 is selectively attached to a holder 14 that is located at the intersection of the diagonal lines of four of the LEDs 6.

Effect of First Embodiment

The following effect can be obtained with the first embodiment.

In the first embodiment, as discussed above, the liquid crystal television device 100 comprises the display unit 1, the rear frame 4 disposed on the back side, which is the opposite side from the display unit 1, the LEDs 6 that are disposed between the display unit 1 and the rear frame 4, the diffuser 10 that is disposed between the display unit 1 and the LEDs 6, the sheet supports 13 that support the diffuser 10 from the back side of the diffuser 10, and the bases 12 that include the holders 14 holding the sheet supports 13 and that are attached to the rear frame 4 from the display unit 1 side. Accordingly, one of the holders 14 at an appropriate position for supporting the diffuser 10 can be selected, and the sheet support 13 can be disposed there. Consequently, unlike when only one holder 14 is provided for holding the sheet support 13, the number of places where the sheet support 13 can be located is limited only by the number of the holders 14. Consequently, a common rear frame 4 can be used even when the product lineup includes different models, and the same rear frame 4 can be shared by all the products. Also, since the bases 12 each include the plurality of holders 14, just one base 12 may be fixed to the rear frame 4 in order to fix one sheet support 13. Accordingly, just a single through-hole (i.e., a single attachment portion 4a) need to be made in the rear frame 4 to fix one base 12 in order to fix one sheet support 13, so there is no need to make a plurality of holes. Therefore, when using a common rear frame 4 that requires different layout design of the light source substrates 7 and in which most of the rear surface will be visible from the outside, it is possible to provide the liquid crystal television device 100 with which each sheet support 13 can be disposed at its proper location, while suppressing an increase in the number of holes made in the rear frame 4.

Also, in the first embodiment, as discussed above, one or more of the bases 12 are provided, and the rear frame 4 includes one attachment portion 4a (in the form of the through-hole) for each base 12, which is used for attaching the base 12 to the rear frame 4. Consequently, in order to provide one sheet support 13, a base 12 can be attached to the rear frame 4 by providing one through-hole 16. Also, since a single base 12 can be provided for one attachment portion 4a of the rear frame 4, there is no need to make a plurality of holes in the rear frame 4. Therefore, unnecessary holes do not have to be made in the rear frame 4, and the base 12 can be fixed by providing the minimum number of holes.

Also, in the first embodiment, as discussed above, the sheet support 13 is selectively attached to any one of the holders 14 of the base 12. Consequently, one of the holders 14 of the base 12 can be selected with respect to the position of the LEDs 6, so the sheet support 13 can be easily disposed at the proper position.

In the first embodiment, as discussed above, the base 12 is provided with at least one through-hole 16 for attaching the base 12 to the rear frame 4, the base 12 is attached to the attachment portion 4a of the rear frame 4 by the screw 18 inserted into the through-hole 16, and the base 12 is configured so that the rotation angle along the rear frame 4 can be adjusted, with the screw 19 at the center. Consequently, unlike when the base 12 can only be fixed at a certain angle with respect to the position of the LEDs 6, the orientation of the base 12 can be freely set with the screw 18 at the center. Accordingly, by adjusting the orientation of the base 12, the position of the sheet support 13 attached to the base 12 can be finely adjusted.

In the first embodiment, as discussed above, the LEDs 6 are disposed in linear rows on the rear frame 4, and the bases 12 are disposed between adjacent rows of the LEDs 6. Consequently, unlike when the LEDs 6 are disposed at random positions, the bases 12 can be disposed between the rows in which the LEDs 6 are formed linearly. Therefore, the bases 12 can be disposed without interfering with the positions of the LEDs 6. Also, if the rows of the LEDs 6 are spaced sufficiently far apart, the bases 12 can be rotated, which makes it easy to precisely adjust the positions of the sheet supports 13 by adjusting the orientation of the bases 12.

Also, in the first embodiment, as discussed above, the arrangement pattern of the LEDs 6 includes the first arrangement pattern P1 in which the LEDs 6 are disposed at substantially equal intervals along the row, and the second arrangement pattern P2 in which the LEDs 6 are disposed at substantially equal intervals along the row but at larger intervals than in the first arrangement pattern P1, and the holders 14 are provided so as to be compatible with both the first arrangement pattern P1 and the second arrangement pattern P2. Consequently, the number of LEDs 6 can be reduced by using the LEDs 6 in the second arrangement pattern P2 in which the LEDs 6 are spaced farther apart. Also, even when the arrangement patterns of the LEDs 6 are different, the position of the sheet supports 13 can be selected. That is, the proper distance between the LEDs 6 and the sheet supports 13 differs depending on the row spacing in the arrangement pattern, but the above configuration allows the sheet supports 13 to be disposed at the proper positions regardless of the arrangement pattern. For products of different models having different light source arrangement patterns, the same rear frame 4 can be used without having to make holes for each arrangement pattern.

Also, in the first embodiment, as discussed above, the bases 12 are attached to the rear frame 4 so that the sheet supports 13 are each positioned on the intersection of the diagonal lines of four of the LEDs 6. Consequently, light interference is more effectively suppressed as compared to when the sheet supports 13 are disposed offset from the intersection of the diagonal lines of four of the LEDs 6, so any shadow produced by the light emitted from the LEDs 6 and irradiating the sheet supports 13 is less likely to appear on the polarizing film 11 side. As a result, it is less likely that the user will see a shadow on the display unit 1 caused by the irradiation of the sheet supports 13 with light.

The holders 14 have the hook mechanisms 19 that fix the sheet support 13. The sheet support 13 is a flat plate including the engaging portions 15 that engage with the hook mechanisms 19, and the holders 14 and the sheet support 13 are configured to be detachable by the hook mechanisms 19. Consequently, when different models of the liquid crystal television device 100 having the same television display size are produced, if the shape of the engaging portions 15 of the sheet support 13 is the same, then the shape of the hook mechanisms 19 of the holders 14 can be maintained. Therefore, by changing the sheet support 13, the optimal sheet support 13 can be selected for each product without having to change the hook mechanisms 19 of the holders 14. Also, since the sheet support 13 is flat in shape, it is easy to design and manufacture the sheet support 13 that is compatible with different models of the liquid crystal television apparatuses 100 having the same television display size.

### Second Embodiment

Next, the configuration of a liquid crystal television device 200 according to a second embodiment will be described. In this second embodiment, the liquid crystal television device 200 includes bases 12 that are modified from the bases 12 of the liquid crystal television device according to the first embodiment. The components that are the same as or similar to those of the first embodiment will be numbered the same and will not be described again.

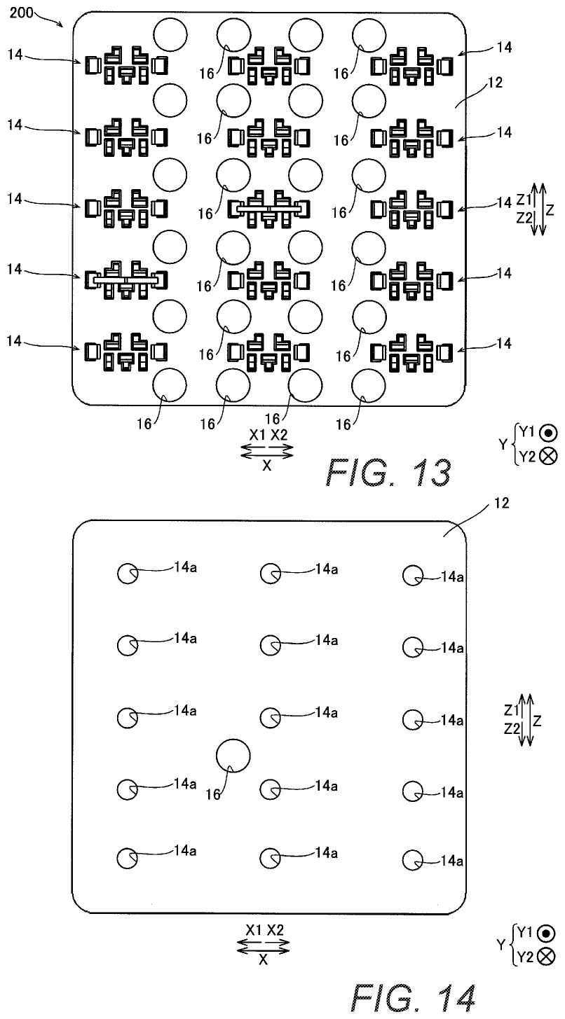

Each of the bases 12 of the liquid crystal television device 200 includes a plurality of through-holes 16 for attaching each of the bases 12 to the rear frame 4. Each of the bases 12 is attached to respective one of the attachment portions 4a of the rear frame 4 by a screw 18 (see FIG. 8) that is inserted into one of the through-holes 16. In the second embodiment, as shown in FIG. 13, the bases 12 are each provided with twenty-four through-holes 16 near the holders 14. The rest of the configuration of the liquid crystal television device 200 according to the second embodiment is the same as that of the liquid crystal television device 100 according to the first embodiment.

Effect of Second Embodiment

The following effect can be obtained with the second embodiment.

In the second embodiment, as discussed above, the liquid crystal television device 200 comprises the display unit 1, the rear frame 4 disposed on the back side, which is the opposite side from the display unit 1, the LEDs 6 that are disposed between the display unit 1 and the rear frame 4, the diffuser 10 that is disposed between the display unit 1 and the LEDs 6; the sheet supports 13 that support the diffuser 10 from the back side of the diffuser 10, and the bases 12 that include the holders 14 holding the sheet supports 13 and that are attached to the rear frame 4 from the display unit 1 side. Accordingly, when only one holder 14 is provided for holding the sheet support 13, the number of places where the sheet support 13 can be located is limited only by the number of the holders 14. Consequently, a common rear frame 4 can be used for different models of display device having the same television display size, so the same rear frame 4 can be shared by all the products. Therefore, when using a common rear frame 4 that requires different layout design of the light source substrates 7 and in which most of the rear surface will be visible from the outside, it is possible to provide the liquid crystal television device 200 with which each sheet support 13 can be disposed at its proper location, while suppressing an increase in the number of holes made in the rear frame 4.

In the second embodiment, as discussed above, in addition to the configuration of the liquid crystal television device 100 according to the first embodiment, each of the bases 12 is provided with the through-holes 16 for attaching each of the bases 12 to the rear frame 4, and each of the bases 12 is attached to respective one of the attachment portions 4a of the rear frame 4 by the screw 18 that is inserted through one of the through-holes 16. Consequently, unlike when only one through-hole 16 is provided in each of the bases 12, the position where each of the bases 12 is fixed (or which through-hole 16 is utilized) can be freely selected with respect to the respective one of the attachment portions 4a formed in the rear frame 4. As a result, the position of the sheet support 13 can be selected more freely according to the selection of the fixing position of the base 12. As a result, any shadow produced by the light irradiating the sheet support 13 is less likely to appear on the optical sheet side.

### Modification Example

The embodiments disclosed herein are just examples in every respect, and should not be interpreted as being limiting in nature. The scope of the invention being indicated by the claims rather than by the above description of the embodiments, all modifications (modification examples) within the meaning and range of equivalency of the claims are included.

For example, in the first and second embodiments above, an example is given in which the liquid crystal television device 100 is used as the display device of the present invention, but the present invention is not limited to this. In the present invention, a display device other than a liquid crystal television device may be used. For instance, any ordinary display device such as a display device or monitor for a PC (personal computer) may be used.

Also, in the first and second embodiments, examples are given in which the bases 12 are provided with the holders 14 for holding the sheet supports 13, but the present invention is not limited to this. As shown in FIG. 14, each of the bases 12 can be provided with a plurality of holder through-holes 14a for holding at least one sheet support 13. The at least one sheet support 13 each can be held by each of the bases 12 by being fixed with a screw 18 or the like, or by providing a hook mechanism 19 or the like to the at least one sheet support 13 and being fixed to at least one of the holder through-holes 14a. With this configuration, the at least one sheet support 13 can have a conical shape, a cylindrical shape, or the like.

Also, in the first and second embodiments above, examples are given in which the bases 12 are provided with the holders 14 for holding the sheet supports 13, but the present invention is not limited to this. The holders 14 for holding the sheet supports 13 may be made up of holders 14 to which the sheet supports 13 are fitted along a direction parallel to the rear frame 4. With this configuration, the sheet supports 13 can be fixed more stably.

Also, in the first and second embodiments above, examples are given in which the bases 12 are attached to the rear frame 4 by the screws 18, but the present invention is not limited to this. The bases 12 can be each provided with hook mechanisms 19 or the like for attaching the bases 12 to the rear frame 4 at the through-holes 16 of the bases 12.

Also, in the first and second embodiments above, examples are given in which a single base 12 has the plurality of the holders 14, but the present invention is not limited to this. Each of the bases 12 may have a plurality of holders 14, and perforations or the like may be made around the holders 14. With this configuration, only the holders 14 that is necessary for the television display size can be cut out for use.

In view of the state of the known technology, a display device according to one aspect of the present disclosure comprises a display, a back member that is disposed on the back side, which is the opposite side from the display, a plurality of light sources that are disposed between the display and the back member, an optical sheet that is disposed between the display and the light sources, sheet supports that support the optical sheet from the back side of the optical sheet, and bases that include a plurality of holders that hold the sheet supports, and that are attached to the back member from the display side. The optical sheet is not limited to being an optical sheet such as a polarizing film, and represents a broader concept of an optical sheet that encompasses a diffuser and the like.

With this display device according to one aspect of the present disclosure, as described above, the display device includes the sheet supports that support the optical sheet from the back side of the optical sheet, and the bases that include the holders that hold the sheet supports and are attached to the back member from the display side. Consequently, unlike when just one holder is provided for holding the sheet support, a number of sheet support locations equal to the number of holders can be selected. Accordingly, the holders in the proper positions for supporting the optical sheet can be selected, and the sheet supports can be disposed properly. Consequently, display devices of different types (models) having the same television display size can use a common back member, which means that the same back member can be used for all of them. Also, since the bases each include the holders, just one base may be fixed to the back member in order to fix one sheet support. Accordingly, since only one base needs to be fixed in order to fix one sheet support, a plurality of holes are not needed. Therefore, even if a common back member is used for display devices of different types having the same television display size, a display device can be provided with which each sheet support can be disposed at the proper position, while suppressing an increase in the number of holes made in the back member.

In accordance with a preferred embodiment according to the display device mentioned above, one or more of the bases are provided, and one back member is provided to a base, and includes one through-hole-shaped attachment portion for attaching the base to the back member. With this configuration, the base can be attached by providing one through-hole to the back member in order to provide one sheet support. Also, since one base can be provided for the attachment portion of one back member, there is no need to provide a plurality of holes in the back member. Therefore, there is no need to make unnecessary holes in the back member, and the base can be fixed by providing the minimum number of holes.

In accordance with a preferred embodiment according to any one of the display devices mentioned above, the sheet support is selectively attached to any one of the holders of the base. With this configuration, one of the holders of the base can be selected with respect to the positions of the light sources, so the sheet support can be easily disposed in the proper position.

In accordance with a preferred embodiment according to any one of the display devices mentioned above, the base is provided with at least one through-hole for attaching the base to the back member, and the base is attached to the attachment portion of the back member by a fastening member inserted into the through-hole. Also, the base is configured to allow the angle of rotation to be adjusted along the back member, with the fastening member at the center. With this configuration, unlike when the base can only be fixed at a fixed angle with respect to the position of the light sources, the orientation of the base can be freely set around the fastening member. Therefore, by adjusting the orientation of the base, the position of the sheet support attached to the base can be finely adjusted.

In accordance with a preferred embodiment according to any one of the display devices mentioned above, the light sources are disposed in linear rows on the back member, and the bases are provided between adjacent rows of light sources. With this configuration, unlike when the light sources are disposed in random positions, the bases can be disposed between the linear rows of the light sources. Therefore, the bases can be disposed without interfering with the positions of the light sources. Also, if the rows of light sources are spaced sufficiently far apart, the bases can be rotated, which makes it easy to precisely adjust the positions of the sheet supports by adjusting the orientation of the bases.

In accordance with a preferred embodiment according to any one of the display devices mentioned above, the arrangement pattern of the light sources includes a first arrangement pattern in which the light sources are disposed at substantially equal intervals along the row, and a second arrangement pattern in which the light sources are disposed at substantially equal intervals along the row but at larger intervals than in the first arrangement pattern, and the holders are provided so as to be compatible with both the first arrangement pattern and the second arrangement pattern. With this configuration, the number of light sources can be reduced by using the light sources of the second arrangement pattern in which the light sources are spaced farther apart. Also, even when the arrangement patterns of the light sources are different, the positions of the sheet supports can be selected. That is, the proper distance between the light sources and the sheet supports differs depending on the row spacing in the arrangement pattern, but the above configuration allows the sheet supports to be disposed at the proper positions regardless of the arrangement pattern. For products of different models having different light source arrangement patterns, the same back member can be used without having to make holes for each arrangement pattern.

In accordance with a preferred embodiment according to any one of the display devices mentioned above, in a configuration in which the distance between the light sources and the holders that hold the sheet supports in the second arrangement pattern is greater than the distance between the light sources and the holders that hold the sheet supports in the first arrangement pattern, the bases are attached to the back member such that the sheet supports are each located at a position on the intersection of the diagonal lines of four of the light sources. With this configuration, light interference is more effectively suppressed as compared to when the sheet supports are disposed offset from the intersection of the diagonal lines of four light sources, so any shadow produced by the light emitted from the light sources and irradiating the sheet supports is less likely to appear on the optical sheet side. As a result, it is less likely that the user will see a shadow on the display caused by the irradiation of the sheet supports with light.

In accordance with a preferred embodiment according to any one of the display devices mentioned above, the bases are provided with a plurality of through-holes for attaching the bases to the back member, and the bases are attached to the attachment portions of the back member by a fastening member inserted through one of the through-holes. With this configuration, unlike when a base has only one through-hole, the position where the base is fixed (or which through-hole is utilized) can be freely selected with respect to the attachment portion made in the back member. As a result, the position of the sheet support can be selected more freely according to the selection of the fixing position of the base.

In accordance with a preferred embodiment according to any one of the display devices mentioned above, the holders have fixing mechanisms for fixing the sheet supports, the sheet supports are flat plates including engaging portions that engage with the fixing mechanisms, and the holders and the sheet supports are configured to be detachable by the fixing mechanisms. With this configuration, when different models of display device having the same television display size are produced, if the shape of the engaging portions of the sheet supports is the same, then the shape of the fixing mechanisms of the holder can be maintained. Therefore, by changing the sheet supports, the optimal sheet support can be selected for each product without having to change the fixing mechanisms of the holders. Also, since the sheet supports are flat in shape, it is easy to design and manufacture sheet supports compatible with different models of display device having the same television display size.

With the display device of the present disclosure, even if a common back member is used for display devices of different types having the same television display size, the increase in the number of holes made in the back member can be suppressed, while individual sheet supports can be disposed at the proper positions.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a user wearing a helmet with an HMD device in an upright position on a horizontal surface. Accordingly, these directional terms, as utilized to describe the display device should be interpreted relative to a display device on a horizontal surface. The terms “left” and “right” are used to indicate the “right” when referencing from the right side as viewed from the front side of the display device, and the “left” when referencing from the left side as viewed from the front side of the display device.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A display device comprising:
a display;
a back member disposed rearward relative to the display;
a plurality of light sources disposed between the display and the back member;
an optical sheet disposed between the display and the light sources;
at least one sheet support supporting the optical sheet from a back side of the optical sheet; and
at least one base including a plurality of holders that are configured to hold the at least one sheet support, the at least one base being attached to the back member from a display side.

2. The display device according to claim 1, wherein
the back member includes at least one attachment portion for attaching the at least one base to the back member, respectively.

3. The display device according to claim 2, wherein
the at least one attachment portion each includes a through-hole.

4. The display device according to claim 1, wherein
the at least one sheet support is selectively attached to the holders of the at least one base.

5. The display device according to claim 2, wherein
the at least one base each includes at least one through-hole for attaching the at least one base to the back member.

6. The display device according to claim 5, wherein
the at least one base is each attached to respective one of the at least one attachment portion of the back member by a fastening member that is inserted into one of the at least one through-hole.

7. The display device according to claim 6, wherein
a rotational angle of each of the at least one base is adjustable about the fastening member along the back member.

8. The display device according to claim 1, wherein
the light sources are arranged in a plurality of light source rows on the back member, each of the light source rows having a set of light sources that are linearly arranged relative to each other.

9. The display device according to claim 8, wherein
the at least one base is each provided between an adjacent pair of the light source rows.

10. The display device according to claim 8, wherein
the light sources are arranged relative to the back member in a first arrangement pattern in which the set of light sources are substantially equidistantly disposed at a first interval along each of the light source rows or a second arrangement pattern in which the set of light sources are substantially equidistantly disposed at a second interval along each of the light source rows, the second interval being larger than the first interval, and
the holders are provided so as to be compatible with both the first arrangement pattern and the second arrangement pattern.

11. The display device according to claim 1, wherein
the at least one base is attached to the back member such that the at least one sheet support is located at an intersection of diagonal lines of four of the light sources.

12. The display device according to claim 2, wherein
the at least one base each includes a plurality of through-holes for attaching the at least one base to the back member.

13. The display device according to claim 12, wherein
the at least one base is each attached to respective one of the at least one attachment portion of the back member by a fastening member that is inserted into one of the through-holes.

14. The display device according to claim 1, wherein
the holders have fixing mechanisms that are configured to be engaged with the at least one sheet support,
the at least one sheet support each includes a flat plate with an engaging portion that engages with respective one of the fixing mechanisms, and
the holders and the at least one sheet support are detachably attachable by the fixing mechanisms.

15. The display device according to claim 1, wherein
the at least one base are each integrally formed as one-piece, unitary member.

16. The display device according to claim 1, wherein
the at least one sheet support is each independently formed as separate members from the at least one base.

17. The display device according to claim 16, wherein
the at least one sheet support is each detachably and reattachably attachable to the at least one base.

18. The display device according to claim 16, wherein
the at least one sheet support is each toollessly attachable to the at least one base.

19. The display device according to claim 1, wherein
the at least one base includes a plurality of bases, and
the back member includes a plurality of through-holes for attaching the bases to the back member, respectively.

20. The display device according to claim 19, wherein
the number of the bases attached to the back member is equal to the number of the through-holes of the back member.
